(19) United States
(12) Patent Application Publication
(10) Pub. No.: US 2026/0255155 A1
(43) Pub. Date: Aug. 27, 2026

(54) RAN INTELLIGENT CONTROLLER (RIC) AND METHOD THEREFOR

(71) Applicant: NEC Corporation, Minato-ku, Tokyo (JP)

(72) Inventors: Yoshinori WATANABE, Tokyo (JP); Kenji KAWAGUCHI, Tokyo (JP); Rumi MATSUMURA, Tokyo (JP); Masayuki UEDA, Tokyo (JP); Hideki KOZUKA, Tokyo (JP); Katsunon DATE, Tokyo (JP); Eiji TAKAHASHI, Tokyo (JP); Takeo ONISHI, Tokyo (JP)

(73) Assignee: NEC Corporation, Minato-ku, Tokyo (JP)

(21) Appl. No.: 18/992,278

(22) PCT Filed: Jul. 6, 2023
(86) PCT No.: PCT/JP2023/025116

§ 371 Date: Jan. 8, 2025

(30) Foreign Application Priority Data
Aug. 12, 2022 (JP) 2022-128679

(51) Int. Cl. H04W 8/26; H04W 76/15; H04W 88/12

(52) U.S. Cl. CPC H04W 8/26; H04W 76/15; H04W 88/12

(57) ABSTRACT

A Radio Access Network (RAN) Intelligent Controller (RIC) (1, 3) obtains a first identifier associated with a User Equipment (UE) (6) and obtains a first type of UE identifier corresponding to the first identifier from a core network (7). The RIC (1, 3) uses the first type of UE identifier or a second type of UE identifier associated with the first type of UE identifier to cause one or more RAN nodes (5) in a RAN (4) to perform control with respect to the UE (6). For example, this helps to enable the RIC to identify a target UE based on user identification information (first identifier) specified by an external server or entity, such as an application server, and to perform continuous control over that target UE.

### TECHNICAL FIELD

The present disclosure relates to interfaces between logical functions, controllers, or systems for controlling and optimizing a radio access network.

### BACKGROUND ART

The Open Radio Access Network (O-RAN) Alliance is a community of mobile operators, vendors, and research and academic institutions, and its mission is to re-shape radio access networks (RANs) to be more intelligent, open, virtualized and fully interoperable. The O-RAN Working Group 2 (WG2) has conducted technical studies and provided technical specifications for the Non-Real-Time (Non-RT) RAN Intelligent Controller (RIC) and the A1 interface (see, for example, Non-Patent Literature 1-5). Meanwhile, the O-RAN Working Group 3 (WG3) has conducted technical studies and provided technical specifications for the Near-Real-Time (Near-RT) RIC and the E2 interface (see, for example, Non-Patent Literature 6-11).

A Non-RT RIC is a logical function within a Service Management and Orchestration (SMO) framework. The SMO framework can be referred to simply as SMO. The Non-RT RIC consists of a Non-RT RIC framework and Non-RT RIC applications (rApps). The Non-RT RIC framework includes functionality to logically terminate A1 interfaces and expose a set of R1 services to rApps. The A1 termination allows the Non-RT RIC framework and a Near-RT RIC to exchange messages on an A1 interface. The set of R1 services includes, among others, A1-related services and O1-related services.

A1-related services include, among others, creating, updating, querying, and deleting A1 policies; querying the enforcement status of A1 policies; and subscribing to event notifications about A1 policies, including notifications of changes in the enforcement status of A1 policies.

O1-related services are provided by one or both of the SMO framework and the Non-RT RIC framework. O1-related services allow rApps to obtain information about alarms, obtain performance information related to the network, obtain the current configuration of the network, provision changes to the network configuration, and obtain additional information related to the network.

The SMO framework provides various logical functions that are not anchored in the Non-RT RIC. These logical functions include, but are not limited to, O1 termination, O2 termination, and external terminations. The O1 termination allows the SMO framework to exchange messages with the Near-RT RIC and E2 Nodes on O1 interfaces.

The Near-RT RIC is a logical function that enables near real time control and optimization of RAN elements and resources through fine-grained data collection and actions on E2 interfaces. The Near-RT RIC hosts a set of applications called xApps and provides a set of platform functions that are commonly used to support specific functions hosted by xApps. The set of platform functions includes interface terminations and other functions. The interface terminations include E2, A1, and O1 terminations, which provide E2 interface termination, A1 interface termination, and O1 interface termination, respectively.

An E2 interface connects the Near-RT RIC to one or more E2 Nodes. An E2 Node is a logical node that terminates an E2 interface. An E2 Node is a RAN node that exposes one or more RAN functions to the Near-RT RIC and hosted xApps. For NR access, E2 Nodes include one or more O-RAN Central Units-Control Plane (O-CU-CPs), one or more O-RAN Central Units-User Plane (O-CU-UPs), one or more O-RAN Distributed Units (O-DUs), or any combination thereof. On the other hand, for Evolved Universal Terrestrial Radio Access (E-UTRA) access, E2 Nodes include one or more O-RAN eNodeBs (O-eNBs).

An E2 Node provides one or more services to the Near-RT RIC, to provide access to messages and measurements, or to allow control of the E2 Node from the Near-RT RIC, or both. These services are called RIC services. The RIC services provided by E2 Nodes that can be used by the Near-RT RIC include four services: REPORT, INSERT, CONTROL, and POLICY services. These RIC services can be combined in different ways to implement an E2 Service Model (E2SM). An E2 Service Model depends on the RAN functions and Radio Access Technology (RAT) of an E2 Node and describes functions in the E2 Node that may be controlled by the Near-RT RIC and related procedures. Currently, the E2 Service Models include E2SM Key Performance Measurement (E2SM-KPM), E2SM Network Interfaces (E2SM-NI), and E2SM RAN Control (E2SM-RC).

An E2 interface provides E2 Application Protocol (E2AP) procedures to enable the exchange of control signaling information between endpoints, to implement RIC services, and to make available to the Near-RT RIC and hosted xApps a set of services described in the E2SM Service Models. These E2AP procedures include RIC Subscription, RIC Subscription Delete, RIC Control, and RIC Indication, among others.

Incidentally, Patent Literature 1 discloses apparatus and methods for Mobile Edge Computing. Specifically, according to FIGS. 4 and 5 and paragraphs [0052]-[0067] of Patent Literature 1, a Mobile Edge Computing (MEC) server obtains a second identifier for identifying a User Equipment (UE) from a core network node. The MEC server associates the received second identifier with a first identifier. The first identifier is used by the MEC server or an application (or service) hosted on the MEC server to identify the UE. The MEC server then communicates with a RAN node using the second identifier. This allows the MEC server (or the MEC application hosted on the MEC server) and the RAN node to directly exchange control messages about a particular UE between each other.

The second identifier may uniquely identify the UE on the interface between the RAN node and a control plane core network node. Alternatively, the second identifier may uniquely identify the UE on the interface between the RAN node and a user plane core network node.

If the mobile network in Patent Literature 1 is that of Long Term Evolution (LTE) and LTE-Advanced, the RAN node can be an eNB and the core network node can be a Mobility Management Entity (MME), a Serving Gateway (S-GW), or Packet Data Network Gateway (P-GW). The first identifier can be a UE Internet Protocol (IP) address or an application layer UE ID (or name). The second identifier can be an S1 eNB Tunnel Endpoint Identifier (TEID), an S1 S-GW TEID, or a combination of these. The second identifier can be a combination of an S1 S-GW TEID and an S-GW identifier (e.g., S-GW address). The second identifier can be an eNodeB UE S1 Application Protocol (S1AP) ID or a combination of an eNodeB UE S1AP ID and an S1 eNB TEID. The second identifier can be a combination of an eNodeB UE S1AP ID and an MME UE S1AP ID. Alternatively, the second identifier can be a combination of an MME UE S1AP ID and an MME identifier (e.g., MME Code (MMEC), MME Identifier (MMEI), Globally Unique MMEI (GUMMEI)).

### CITATION LIST

### Patent Literature

[Patent Literature 1] WO 2017/099165 A1

### Non Patent Literature

[Non-Patent Literature 1] O-RAN ALLIANCE Working Group 2, “O-RAN Non-RT RIC Architecture 2.0”, O-RAN.WG2.Non-RT-RIC-ARCH-TS-v02.00, July 2022
[Non-Patent Literature 2] O-RAN ALLIANCE Working Group 2, “O-RAN Non-RT RIC & A1 Interface: Use Cases and Requirements 6.0”, O-RAN.WG2.Use-Case-Requirements-v06.00, July 2022
[Non-Patent Literature 3] O-RAN ALLIANCE Working Group 2, “O-RAN A1 interface: General Aspects and Principles 2.03”, O-RAN.WG2.A1GAP-v02.03, October 2021
[Non-Patent Literature 4] O-RAN ALLIANCE Working Group 2, “O-RAN A1 interface: Application Protocol 3.02”, O-RAN.WG2.A1AP-v03.02, July 2022
[Non-Patent Literature 5] O-RAN ALLIANCE Working Group 2, “O-RAN A1 interface: Type Definitions 3.0”, O-RAN.WG2.A1TD-v03.00, July 2022
[Non-Patent Literature 6] O-RAN ALLIANCE Working Group 3, “O-RAN Near-Real-time RAN Intelligent Controller Near-RT RIC Architecture 2.01”, O-RAN.WG3.RICARCH-v02.01, March 2022
[Non-Patent Literature 7] O-RAN ALLIANCE Working Group 3, “O-RAN Near-Real-time RAN Intelligent Controller Architecture & E2 General Aspects and Principles 2.02”, O-RAN.WG3.E2GAP-v02.02, July 2022
[Non-Patent Literature 8] O-RAN ALLIANCE Working Group 3, “O-RAN Near-Real-time RAN Intelligent Controller, E2 Application Protocol (E2AP) 2.02”, O-RAN.WG3.E2AP-v02.02, July 2022
[Non-Patent Literature 9] O-RAN ALLIANCE Working Group 3, “O-RAN Near-Real-time RAN Intelligent Controller E2 Service Model (E2SM) 2.01”, O-RAN.WG3.E2SM-v02.01, March 2022
[Non-Patent Literature 10] O-RAN ALLIANCE Working Group 3, “O-RAN Near-Real-time RAN Intelligent Controller E2 Service Model (E2SM) KPM 2.02”, O-RAN.WG3.E2SM-KPM-v02.02, July 2022
[Non-Patent Literature 11] O-RAN ALLIANCE Working Group 3, “O-RAN Near-Real-time RAN Intelligent Controller E2 Service Model (E2SM), RAN Control 1.02”, O-RAN.WG3.E2SM-RC-v01.02, July 2022

### SUMMARY OF INVENTION

### Technical Problem

The inventors have studied the RAN control for UEs by the Non-RT RIC and the Near-RT RIC and found problems. One of these problems relates to continuous control of certain UEs. One of these problems relates to enhancements that allow the Non-RT RIC and the Near-RT RIC to identify a target UE based on user identification information specified by an external server or entity, such as an application server, and to perform continuous control over the target UE. The user identification information may be, for example, an identifier used for user, UE, or device identification in applications that utilize connectivity or communication services (e.g., Protocol Data Unit (PDU) connectivity services provided by a 5G network) provided by a radio communication network, including the RAN managed by the O-RAN RICs. First, the current O-RAN technical specifications are not clear on how the Non-RT RIC and the Near-RT RIC identify the target UE from the user identification information specified by the external server. Second, the Non-RT RIC can create an A1 policy that identifies the target UE by a UE identifier based on a RAN UE ID and request the Near-RT RIC to take control of the target UE by providing this A1 policy to the Near-RT RIC. The UE identifier based on the RAN UE ID is a UE identifier assigned by a RAN node, such as a gNB-CU-CP UE E1AP ID, a gNB-CU-UP UE E1AP ID, a gNB-DU UE F1AP ID, or a gNB-CU UE F1AP ID. However, the value of such a UE identifier will change if the RAN node to which the UE is connected changes due to handover or other reasons. For example, assuming a situation where the RAN node to which the UE is connected changes frequently, the update process between the Non-RT RIC and the Near-RT RIC may occur frequently in response to frequent changes of the UE identifier.

Patent Literature 1 discloses that the MEC server associates the first identifier of the UE at the application layer with the second identifier used in the core network (e. g., MME UE S1AP ID and MME identifier) and communicates with the RAN node using the second identifier. However, Patent Literature 1 does not provide an explicit description associated with the RIC.

Another problem identified by the inventors relates to various enabling technologies that enable or enhance the above improvements. The current O-RAN technical specifications do not require the Non-RT RIC to provide the Near-RT RIC with a UE identifier assigned by the core network, rather than the RAN, for control or policy provisioning with respect to a target UE. In addition, the current O-RAN technical specifications do not provide an adequate method for the Near-RT RIC to inform the Non-RT RIC of changes in the value of a UE identifier assigned by the core network rather than the RAN.

One of the objects to be achieved by the example embodiments disclosed herein is to provide apparatus, methods, and programs that contribute to solving at least one of a plurality of problems, including the problems described above. It should be noted that this object is only one of the objects to be achieved by the example embodiments disclosed herein. Other objects or problems and novel features will become apparent from the following description and the accompanying drawings.

### Solution to Problem

In a first aspect, a RIC includes at least one memory and at least one processor coupled to the at least one memory. The at least one processor is configured to obtain a first identifier associated with a UE and to obtain a first type of UE identifier corresponding to the first identifier from a core network. The at least one processor is configured to use the first type of UE identifier or a second type of UE identifier associated with the first type of UE identifier to cause one or more RAN nodes in a RAN to perform control with respect to the UE.

In a second aspect, a method performed by a RIC includes the steps of:
(a) obtaining a first identifier associated with a UE;
(b) obtaining a first type of UE identifier corresponding to the first identifier from a core network; and
(c) using the first type of UE identifier or a second type of UE identifier associated with the first type of UE identifier to cause one or more RAN nodes in a RAN to perform control with respect to the UE.

In a third aspect, a first RIC includes at least one memory and at least one processor coupled to the at least one memory. The at least one processor is configured to send a first type of UE identifier of a UE assigned by a core network to a second RIC located between the first RIC and a RAN.

In a fourth aspect, a method performed by a first RIC includes sending a first type of UE identifier of a UE assigned by a core network to a second RIC located between the first RIC and a RAN.

A fifth aspect is directed to a second RIC to be deployed between a first RIC and one or more RAN nodes. The second RIC includes at least one memory and at least one processor coupled to the at least one memory. The at least one processor is configured to receive from the first RIC a first type of UE identifier of a UE assigned by a core network.

A sixth aspect is directed to a method performed by a second RIC to be deployed between a first RIC and one or more RAN nodes. The method includes receiving from the first RIC a first type of UE identifier of a UE assigned by a core network.

In a seventh aspect, a first RIC includes at least one memory and at least one processor coupled to the at least one memory. The at least one processor is configured to receive, from a second RIC located between the first RIC and a RAN, a notification indicating a change in a value of a first type of UE identifier of a UE assigned by a core network.

In an eighth aspect, a method performed by a first RIC includes receiving, from a second RIC located between the first RIC and a RAN, a notification indicating a change in a value of a first type of UE identifier of a UE assigned by a core network.

A ninth aspect is directed to a second RIC to be deployed between a first RIC and one or more RAN nodes. The second RIC includes at least one memory and at least one processor coupled to the at least one memory. The at least one processor is configured to send to the first RIC a notification indicating a change in a value of a first type of UE identifier of a UE assigned by a core network.

A tenth aspect is directed to a method performed by a second RIC to be deployed between a first RIC and one or more RAN nodes. The method includes sending to the first RIC a notification indicating a change in a value of a first type of UE identifier of a UE assigned by a core network.

An eleventh aspect is directed to a program. The program includes a set of instructions (software code) that, when read into a computer, causes the computer to perform the method according to the second, fourth, sixth, eighth, or tenth aspect described above.

### Advantageous Effects of Invention

According to the aspects described above, it is possible to provide apparatuses, methods, and programs which contribute to solving at least one of the problems mentioned above.

### BRIEF DESCRIPTION OF DRAWINGS

FIG. 1 shows the configuration of a communication system or network according to an embodiment;

FIG. 2 shows the configuration of a communication system or network according to an embodiment;

FIG. 3 is a flowchart showing an example of the operation performed by a Non-RT RIC or a Near-RT RIC according to an embodiment;

FIG. 4 is a flowchart showing an example of the operation performed by a Non-RT RIC or a Near-RT RIC according to an embodiment;

FIG. 5 is a sequence diagram showing an example of the operation of a Non-RT RIC and a Near-RT RIC according to an example embodiment;

FIG. 6 is a sequence diagram showing an example of the operation of a Non-RT RIC and a Near-RT RIC according to an example embodiment;

FIG. 7 is a sequence diagram showing an example of the operation of a Non-RT RIC and a Near-RT RIC according to an example embodiment;

FIG. 8 is a sequence diagram showing an example of the operation of a Non-RT RIC and a Near-RT RIC according to an example embodiment; and

FIG. 9 is a block diagram showing an example configuration of a Non-RT RIC and a Near-RT RIC according to an example embodiment.

### EXAMPLE EMBODIMENT

Specific example embodiments will be described hereinafter in detail with reference to the drawings. Identical or corresponding elements are designated by the same symbols throughout the drawings, and duplicate explanations are omitted where necessary for the sake of clarity.

The multiple example embodiments described below may be implemented independently or in any suitable combination. These multiple example embodiments have novel features that differ from one another. Accordingly, these multiple example embodiments contribute to achieving different objectives or solving different problems and contribute to achieving different advantages.

The following example embodiments are described primarily with respect to a Non-RT RIC and a Near-RT RIC in accordance with the O-RAN technical specifications. However, these example embodiments can be applied to other systems that support technologies similar to the O-RAN Non-RT RIC and Near-RT RIC.

As used in this specification, “if” can be interpreted to mean “when”, “at or around the time”, “after”, “upon”, “in response to determining”, “in accordance with a determination”, or “in response to detecting”, depending on the context. These expressions can be interpreted to mean the same thing, depending on the context.

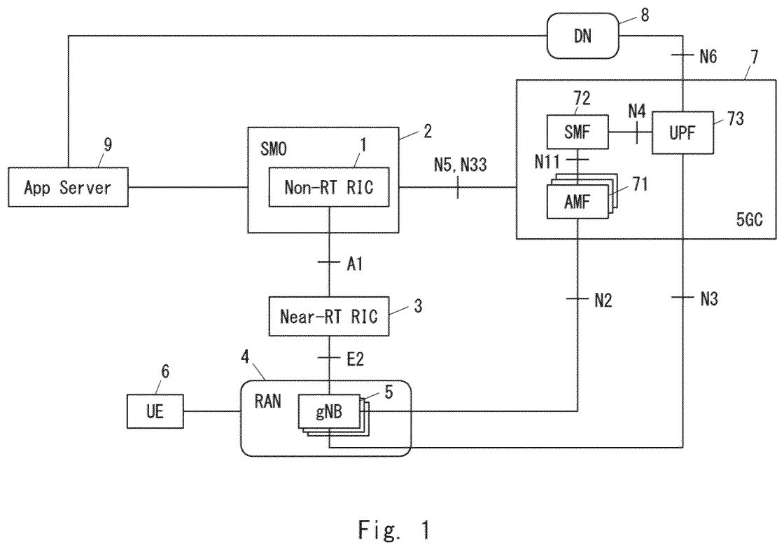

First, the configurations and operations of a plurality of elements that are common to a plurality of example embodiments are described. FIG. 1 shows an example configuration of a communication system or network according to a plurality of example embodiments. In the example in FIG. 1, the system includes a Non-RT RIC 1, an SMO framework 2, a Near-RT RIC 3, a RAN 4, and a 5G Core Network (5GC) 7. The SMO framework 2 may be referred to simply as SMO. Each element (network function) shown in FIG. 1 can be implemented, for example, as a network element on dedicated hardware, as a software instance running on dedicated hardware, or as a virtualized function instantiated on an application platform.

The Non-RT RIC 1 is a logical function within the SMO or within the SMO framework 2. The Non-RT RIC 1 includes a Non-RT RIC framework and Non-RT RIC Applications (rApps). The Non-RT RIC framework includes the functionality to logically terminate an A1 interface and expose a set of R1 services to rApps. The A1 termination allows the Non-RT RIC framework and the Near-RT RIC to exchange messages on an A1 interface. The set of R1 services includes A1 related services, O1-related services, and other services.

A1-related services include, among others, creating, updating, querying, and deleting A1 policies; querying the enforcement status of A1 policies; and subscribing to event notifications about A1 policies, including notifications of changes in the enforcement status of A1 policies.

O1-related services are provided by the SMO framework 2 and the Non-RT RIC framework. O1-related services allow rApps to obtain information about alarms, obtain performance information related to the network, obtain the current configuration of the network, provision changes to the configuration of the network, and obtain additional information related to the network.

The SMO framework 2 provides various logical functions that are not anchored within the Non-RT RIC 1. These logical functions include O1 termination, O2 termination, external terminations, and other functions. The O1 termination allows the SMO framework 1 to exchange messages with the Near-RT RIC 3 and E2 Nodes on O1 interfaces. The O2 termination allows the SMO framework 2 to exchange messages with an O-Cloud on an O2 interface. The O-Cloud is a cloud computing platform consisting of a collection of physical infrastructure nodes that meet O-RAN requirements and host relevant O-RAN functions, supporting software components, and appropriate management and orchestration capabilities. The relevant O-RAN functions include, for example, a Near-RT RIC and E2 Nodes. The external terminations allow the SMO framework 2 or a Non-RT RIC framework to exchange messages with external entities via interfaces outside the scope of the O-RAN.

The Near-RT RIC 3 is a logical function that enables near real time control and optimization of RAN elements and resources through fine-grained (e.g., UE basis, cell basis) data collection and actions on E2 interfaces. The Near-RT RIC hosts a set of applications called xApps and provides a set of platform functions that are commonly used to support specific functions hosted by xApps. The set of platform functions includes Database and Shared Data Layer (SDL), xApp subscription management, conflict mitigation, messaging infrastructure, interface termination, and application programming interface (API) enablement. The interface terminations include E2, A1, and O1 terminations, which provide E2 interface termination, A1 interface termination, and O1 interface termination, respectively.

The RAN 4 includes one or more RAN nodes. In the O-RAN framework, a RAN node is referred to as an E2 Node. An E2 Node is a logical node that terminates the E2 interface and exposes one or more RAN functions to the Near-RT RIC 3 and hosted xApps.

In the example in FIG. 1, the RAN 4 is a Next Generation RAN (NG-RAN) and includes one or more gNBs 5. The gNBs 5 are just an example of RAN nodes or E2 Nodes. For example, if the Central Unit (CU)-Distributed Unit (DU) separation is applied, each gNB 5 may contain one gNB Central Unit (CU) and one or more gNB Distributed Units (DUs). If the Control Plane (CP)-User Plane (UP) separation is further applied, a gNB-CU may include a gNB-CU-CP and a gNB-CU-UP. The RAN 4 may include other types of RAN nodes instead of or in addition to the gNBs 5. For example, the RAN 4 may include other NG-RAN nodes. The other NG-RAN nodes may include one or more ng-eNBs. Each ng-eNB may include one ng-eNB-CU and one or more ng-eNB-DUs. Each ng-eNB-CU may include one ng-eNB-CU-CP and one or more ng-eNB-CU-UPs. If the RAN 4 is or includes an Evolved Universal Terrestrial Radio Access Network (E-UTRAN), the RAN 4 may include one or more eNBs.

The 5GC 7 includes one or more Access and Mobility Management Functions (AMFs) 71, one or more Session Management Functions (SMFs) 72, and one or more User Plane Functions (UPFs) 73. The AMF 71 is one of the network functional nodes in the control plane of the 5GC 7. The AMF 71 provides termination of the RAN Control Plane (CP) interface (i.e., the N2 interface). The AMF 71 terminates a single signalling connection (i.e., NI NAS signalling connection) with the UE 6 and provides registration management, connection management, and mobility management.

The SMF 72 is one of the network function nodes in the control plane of the 5GC 7. The SMF 72 manages PDU Sessions. The SMF 72 sends and receives SM signaling messages (NAS-SM messages, N1 SM messages) to and from the Non-Access-Stratum (NAS) of the UE 6 using the communication services provided by the AMF 71.

The UPF 73 is one of the network function nodes in the user plane of the 5GC 7. The UPF 73 processes and forwards user data. The functionality of the UPF 73 is controlled by the SMF 72. The UPF 73 can contain multiple UPFs connected via the N9 interface. The UP path (or route) for a single PDU Session for the UE 6 may include one or more PDU Session Anchor (PSA) UPFs, one or more Intermediate UPFs (I-UPFs), and one or more Uplink Classifier (UL CL) UPFs (or Branching Point (BP) UPFs). The UP path for a PDU Session is set up within the 5GC 7 to route the user plane data (e. g., Internet Protocol (IP) packets) of that PDU Session from the UE 6 to the DN 8 and vice versa. The UP path includes at least one UPF 73 and includes an N6 interface with the DN 8. The UP path can include one or more N9 tunnels. An N9 tunnel is a tunnel between two UPFs.

The 5GC 7 may also include other network functions that are not shown. For example, the 5GC 7 may include a Policy Control Function (PCF), a Unified Data Management (UDM), and a Network Exposure Function (NEF).

The PCF is one of the network function nodes in the control plane of the 5GC 7. The PCF supports interactions with access and mobility policy enforcement in the AMF 71. The PCF provides access and mobility management-related policies to the AMF 71. The PCF also provides session-related policies to the SMF 72.

The UDM is one of the network function nodes in the control plane of the 5GC 7. The UDM provides access to a database (i.e., User Data Repository (UDR)) containing subscriber data (or subscription information).

The NEF is one of the network function nodes in the control plane of the 5GC 7. The NEF has a role similar to that of the Service Capability Exposure Function (SCEF) in the Evolved Packet System (EPS). Specifically, the NEF supports the exposure of services and capabilities from the 3rd Generation Partnership Project (3GPP) system (e.g., 5GC 7) to applications and network functions inside and outside the operator network.

An application server 9 may use connectivity or communication services (i.e., PDU connectivity services) provided by the 5GC 7 and the RAN 4 to communicate with an application running on a processor of the UE 6 (or on a processor of a machine, vehicle, or device coupled to or using the UE 6). The application server 9 may contain one or more servers. The one or more servers may provide different functions from each other. For example, one server may communicate with the UE 6 on the application layer, while another server may provide the interface to the Non-RT RIC 1 or the SMO framework 2. These servers can be distributed. For example, the application server 9 may include a central server as well as one or more edge computing servers located near the RAN 4.

The UE 6 connects to one or more RAN nodes (e.g., gNBs 5) in the RAN 4 via the air interface and further connects to the 5GC 7 via the RAN 4. The UE 6 communicates with the DN 8 via user plane connectivity (i.e., PDU Session) provided by the RAN 4 and the 5GC 7. The UE 6 may be referred to by other terms such as radio terminal, mobile terminal, mobile station, or wireless transmit receive unit (WTRU). The UE 6 may be implemented in a machine, vehicle, or device. By way of example, but not limitation, the UE 6 can be implemented in a machine, vehicle, or device with mobility, and more specifically, in an automated guided vehicle (AGV), a mobile robot, or a construction machine.

In the example in FIG. 1, the Non-RT RIC 1 or the SMO framework 2 provides the termination of the interface with the 5GC 7. This interface can be an N5 interface or an N33 interface. The N5 interface is the interface or reference point between a PCF and an Application Function (AF) in 3GPP scope or terminology. The N33 interface is the interface or reference point between a NEF and an AF. In other words, the Non-RT RIC 1 or the SMO framework 2 may operate as an AF. Depending on the policy of the network operator providing the 5GC 7, the Non-RT RIC 1 or SMO Framework 2 acting as an AF may interact directly with the network functions within the 5GC 7. Otherwise, the Non-RT RIC 1 or the SMO Framework 2 interacts with the network functions within the 5GC 7 via the NEF.

Furthermore, in the example in FIG. 1, the Non-RT RIC 1 or the SMO framework 2 provides the termination of the interface with the application server 9.

The RAN 4 and the 5GC 7 shown in FIG. 1 can be provided by a Mobile Network Operator (MNO) or can be a Non-Public Network (NPN) provided by a non-MNO. If it is an NPN, it can be an independent network, referred to as a Stand-alone Non-Public Network (SNPN), or an NPN in conjunction with an MNO network, referred to as a Public network integrated NPN (PNI-NPN).

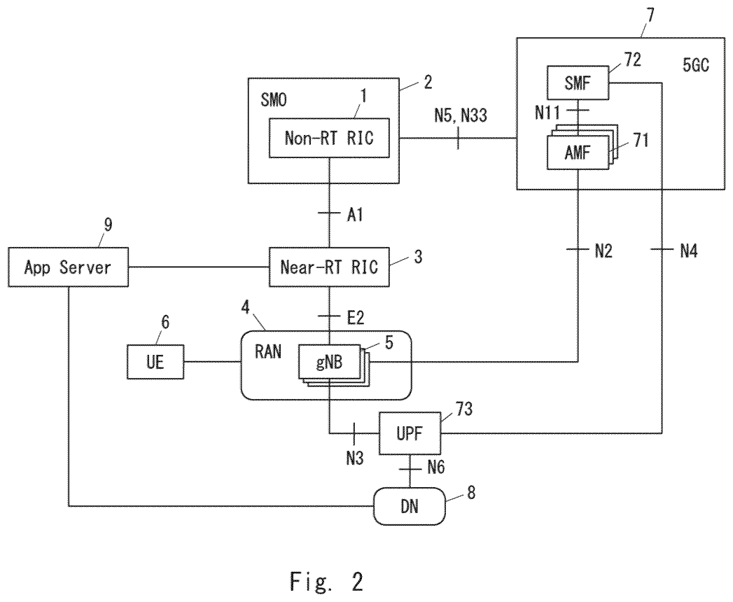

FIG. 2 shows a variant of the arrangement shown in FIG. 1. In the example in FIG. 2, the Near-RT RIC 3 provides the interface termination to the application server 9. In the example in FIG. 2, a (PSA) UPF 73 is also placed near the RAN 4 for local access near the RAN 4 to the DN 8. Such a UPF can be called a local UPF. The UPF 73 may share computing resources with some of the functions of the gNB 5. In other words, the UPF 73 may be collocated with any RAN node. Alternatively, the UPF 73 may be collocated at a network aggregation site between the RAN 4 and the 5GC 7.

The arrangements shown in FIGS. 1 and 2 can be modified as needed. The arrangement of the UPF 73 shown in the examples in FIGS. 1 and 2 is an example. For example, even if the application server 9 has an interface with the Near-RT RIC 3 as shown in FIG. 2, the UPF 73 may be located at the central site similar to that shown in FIG. 1. Conversely, even if the application server 9 has an interface with the Non-RT RIC 1 as shown in FIG. 1, the UPF 73 may be located at a local site similar to that shown in FIG. 2. The gNBs 5 and the 5GC 7 may be replaced by corresponding elements of other wireless networks, e. g., EPS. Specifically, the RAN 4 may include eNBs. A core network (e.g., Evolved Packet Core (EPC)) instead of the 5GC 7 may include MME, S-GW, P-GW, PCRF, Home Subscriber Server (HSS), and SCEF, etc.

### First Example Embodiment

An example configuration of a radio communication system according to this example embodiment may be the same as the example shown in FIG. 1 or FIG. 2. This example embodiment provides examples of operations performed by the Non-RT RIC 1, the Near-RT RIC 3, or a combination of the two.

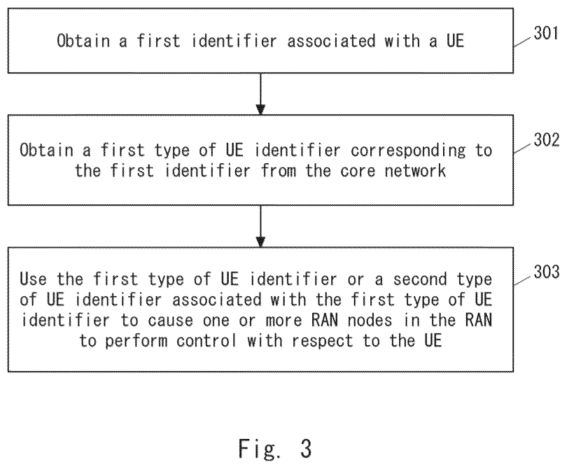

FIG. 3 shows examples of operations performed by one or a combination of the Non-RT RIC 1 and the Near-RT RIC 3. In the following description of FIG. 3, the term “RIC” may refer to one or a combination of the Non-RT RIC 1 and the Near-RT RIC 3, unless otherwise noted.

In step 301, the RIC obtains a first identifier associated with the UE 6. The first identifier may be referred to as the first identification information. The RIC may obtain the first identifier from the application server 9. The RIC may obtain the first identifier from the application server 9 via an external interface. The external interface may be provided by the Non-RT RIC 1, the SMO framework 2, or the Near-RT RIC 3. In the example configuration shown in FIG. 1, the Non-RT RIC 1 may receive the first identifier from the application server 9 via an external interface provided by the Non-RT RIC 1 or the SMO framework 2. In the example configuration shown in FIG. 2, the Near-RT RIC 3 may receive the first identifier from the application server 9 via an external interface of the Near-RT RIC 3.

In one example, the first identifier may be an identifier (e.g., AGV ID) for identifying a machine, vehicle, or device that uses the UE 6 or in which the UE 6 is implemented. Additionally or alternatively, the first identifier may include an identifier for identifying a user or application that uses the UE 6. In other words, the first identifier may include an identifier of an application running on a processor of the UE 6. The first identifier may include an identifier of an application running on a processor of a machine, vehicle, or device coupled to the UE 6. Additionally or alternatively, the first identifier may be an IP address for identifying a packet transfer service, PDU Session, or Packet Data Network (PDN) Connection used by the UE 6. The packet transfer service means a connectivity service provided by the RAN 4 and the 5GC 7.

In step 302, the RIC obtains a first type of UE identifier corresponding to the first identifier from the core network (e.g., 5GC 7). Specifically, in the example configuration shown in FIG. 1, the Non-RT RIC 1 may receive the first type of UE identifier directly from the AMF 71 or the SMF 72 within the 5GC 7, or through another network element such as the PCF or the NEF. The Non-RT RIC 1 may request the 5GC 7 to send or provide the first type of UE identifier. The Non-RT RIC 1 may query the 5GC 7 for the first type of UE identifier. The Non-RT RIC 1 may query the 5GC 7 for the first type of UE identifier using the first identifier or a second identifier associated with the first identifier. The second identifier may include, for example, but is not limited to, a Subscription Permanent Identifier (SUPI), an International Mobile Subscriber Identity (IMSI), or a Generic Public Subscription Identifier (GPSI). The Non-RT RIC 1 may maintain a mapping list between the first identifier and the second identifier. This mapping list may be stored in a memory accessible to the Non-RT RIC 1. This mapping list may be prepared in advance by the operator.

In the example configuration shown in FIG. 2, the Near-RT RIC 3 may receive the first type of UE identifier from the 5GC 7 via the Non-RT RIC 1. In particular, the Near-RT RIC 3 may send to the Non-RT RIC 1 the first identifier received from the application server 9 or a second identifier associated with the first identifier. The Near-RT RIC 3 may request the Non-RT RIC 1 to provide the first type of UE identifier corresponding to the first identifier (or the second identifier). The Near-RT RIC 3 may then receive from the Non-RT RIC 1 the first type of UE identifier obtained by the Non-RT RIC 1 from the 5GC 7 in response to the request using the first identifier (or the second identifier). The Near-RT RIC 3 may send the first identifier (or the second identifier) to the Non-RT RIC 1 via a request to create or enforce an A1 enrichment information job indicating the first identifier (or the second identifier). The Near-RT RIC 3 may then receive the first type of UE identifier from the Non-RT RIC 1 using a delivery procedure to provide a result of the A1 enrichment information job.

The first type of UE identifier is a UE identifier that is known to both the RAN 4 and the 5GC 7. Accordingly, the first type of UE identifier can be a UE identifier assigned by a RAN node (e.g., gNB 5) within the RAN 4, for example, a combination of a gNB UE NGAP ID and a gNB ID (e.g., Global gNB ID). However, it is preferable to avoid frequent changes in the value of the first type of UE identifier. From this perspective, it is preferable that the first type of UE identifier is an identifier assigned by the core network (e.g., 5GC 7 or EPC). The first type of UE identifier may be assigned by the core network on a control interface (e.g., N2 or NG-C interface) between the core network (e.g., 5GC 7 or EPC) and the RAN 4. In other words, the first type of UE identifier may be assigned by the core network to identify the UE 6 on the control interface between the core network and the RAN 4. The first type of UE identifier may be assigned by a control node (e.g., AMF 71 or MME) located within the core network (e.g., 5GC 7 or EPC) and providing mobility management for the UE 6. If the first type of UE identifier is obtained from the 5GC 7, the first type of UE identifier may include an AMF UE NGAP ID, or it may be a combination of an AMF UE NGAP ID and an AMF identifier. The AMF identifier may be all or part of a Globally Unique AMF Identifier (GUAMI). If the first type of UE identifier is obtained from the EPC, the first type of UE identifier may include an MME UE S1AP ID, or it may be a combination of an MME UE S1AP ID and an MME identifier. The MME identifier may be all or part of a Globally Unique MME Identifier (GUMMEI).

In step 303, the RIC uses the first type of UE identifier or a second type of UE identifier associated with the first type of UE identifier to cause one or more RAN nodes (e.g., gNBs 5) in the RAN 4 to perform control with respect to the UE 6. Specifically, in the example configuration shown in FIG. 1, the Non-RT RIC 1 may request the Near-RT RIC 3, based on the first type of UE identifier, to enforce an A1 policy with respect to the UE 6. In other words, the Non-RT RIC 1 may provide the first type of UE identifier to the Near-RT RIC 3 by requesting the Near-RT RIC 3 to create or enforce an A1 policy defined using the first type of UE identifier.

In this case, the UE identifier contained in the scope identifier in the A1 policy may be extended to specify the first type of UE identifier (e.g., AMF UE NGAP ID and AMF identifier). The A1 policy consists of the scope identifier and the one or more policy statements. The scope identifier indicates the target to which the policy statement(s) are to be applied (e.g., UEs, Quality of Service (QoS) flows, or cells). The policy statement(s) represent the goals to the Near-RT RIC 3 and cover policy objectives and policy resources.

In the example configurations shown in FIGS. 1 and 2, the Near-RT RIC 3 may request a RAN node (e.g., gNB 5, gNB-CU, or gNB-CU-CP) to perform control with respect to the UE 6 using the first type of UE identifier of the UE 6. The Near-RT RIC 3 may receive from one or more RAN nodes via the E2 interface a list of the first type of UE identifiers of the UEs connected to each RAN node. The Near-RT RIC 3 may select a RAN node that has provided a list containing the value of the first type of UE identifier of the UE 6 obtained from the core network (e.g., 5GC 7) and request the selected RAN node to perform control with respect to the UE 6. By way of example, but not limitation, the control with respect to the UE 6 may be QoS control for a device running a mission-critical type application that requires a specified latency condition or throughput condition, or both, to be met. The mission-critical type application may be, for example, a device control or video surveillance application. For example, the Near-RT RIC 3 may request the RAN node to perform QoS control with a specified packet delay budget (PDB) for a radio bearer of the UE 6.

Alternatively, the Near-RT RIC 3 may request a RAN node to perform control with respect to the UE 6 by using the second type of UE identifier of the UE 6. In particular, the Near-RT RIC 3 may use the second type of UE identifier to request that the RAN node 2, which does not have a control plane connection to the core network, to perform control with respect to the UE 6. Such a RAN node may be, for example, a DU (e.g., gNB-DU) in the case where CU-DU separation is applied, a CU-UP (e.g., gNB-CU-UP) in the case where CP-UP separation is applied, or a secondary node (e.g., Secondary gNB) in the case where Dual Connectivity is set up. The second type of UE identifier may be a gNB-CU UE F1AP ID for controlling a gNB-DU. The second type of UE identifier may be a gNB-CU-CP UE E1AP ID for controlling a gNB-CU-UP. Alternatively, the second type of UE identifier may include an M-NG-RAN node UE XnAP ID for controlling a secondary node.

According to the operation described with reference to FIG. 3, the Non-RT RIC 1, the Near-RT RIC 3, or a combination thereof obtains from the core network (e.g., the 5GC 7) the first type of UE identifier corresponding to the user identification information (i.e., the first identifier) specified by the external server (e. g., the application server 9). This allows the Non-RT RIC 1, the Near-RT RIC 3, or a combination thereof to identify the target UE corresponding to the user identification information specified by the external server.

In addition, as mentioned above, in one of the preferred examples, the first type of UE identifier may be an identifier assigned by the core network. This can help to avoid frequent changes in the first type of UE identifier. For example, this can avoid increasing the number of updates between the Non-RT RIC 1 and the Near-RT RIC 3 due to frequent changes in the value of the first type of UE identifier.

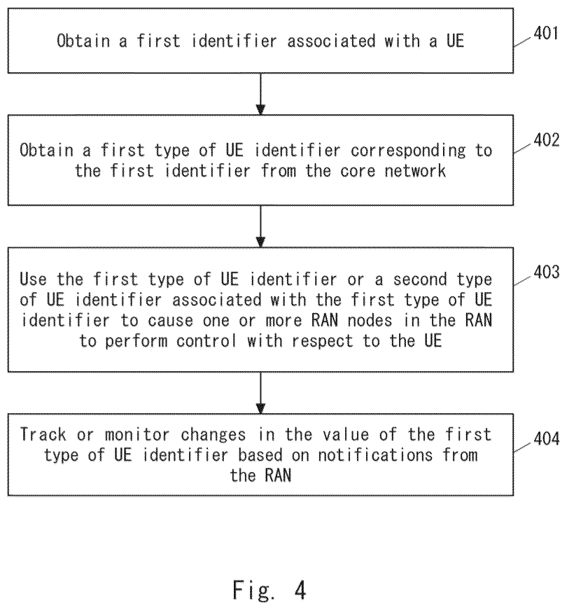

FIG. 4 shows an example of a modification of the operation shown in FIG. 3. FIG. 4 shows examples of operations performed by one or a combination of the Non-RT RIC 1 and the Near-RT RIC 3. In the following description of FIG. 4, the term “RIC” may refer to one or a combination of the Non-RT RIC 1 and the Near-RT RIC 3, unless otherwise noted.

Steps 401 to 403 in FIG. 4 are the same as steps 301 to 303 in FIG. 3. In step 404, the RIC tracks or monitors changes in the value of the first type of UE identifier based on notifications from the RAN 4. More specifically, the RIC receives a notification from the RAN 4 indicating a change in the value of the first type of UE identifier and updates the association between the first identifier and the first type of UE identifier. In other words, the RIC tracks or monitors changes in the value of the first type of UE identifier based on notifications from the RAN 4 and thereby keeps the association between the first identifier and the first type of UE identifier up to date.

That is, after the RIC has learned the first type of UE identifier corresponding to the first identifier by querying the core network (e.g., 5GC 7), the RIC tracks changes to the value of the first type of UE identifier based on notifications from the RAN 4. As a result, based on the updated value of the first type of UE identifier, the RIC can request the RAN node that manages the updated value to control the UE 6.

In the example configuration shown in FIG. 1, the Non-RT RIC 1 may receive a notification indicating a change in the value of the first type of UE identifier from the Near-RT RIC 3 via the A1 interface. Typically, information collection on the A1 interface takes less time than information collection on the O1 interface. Accordingly, the Non-RT RIC 1 may learn of a change in the value of the first type of UE identifier more quickly than when using the O1 interface.

For example, the Non-RT RIC 1 may receive a notification from the Near-RT RIC 3 indicating a change in the value of the first type of UE identifier via policy feedback regarding an A1 policy. Note that existing policy feedback regarding an A1 policy on the A1 interface can only indicate non-enforcement of the A1 policy and a brief cause of non-enforcement. Specifically, a policy feedback can only indicate that the cause of non-enforcement is “SCOPE_NOT_APPLICABLE”, “STATEMENT_NOT_APPLICABLE”, or “OTHER_REASON”. To address this issue, in this example embodiment, the A1 policy feedback may be improved or enhanced to indicate the changed value of the first type of identifier. Alternatively, the A1 policy feedback may be improved or enhanced to indicate the old value before the change and the new value after the change of the first type of UE identifier.

In another example, the Non-RT RIC 1 may receive a notification from the Near-RT RIC 3 indicating a change in the value of the first type of UE identifier in one or more new A1 policy procedures different from the feedback policy procedure. The newly defined procedure(s) may include a push-type procedure similar to the feedback policy procedure. Alternatively, the newly defined procedure(s) may include a pull-type procedure involving a query from the Non-RT RIC 1 and a response from the Near-RT RIC 3.

In the example configurations shown in FIGS. 1 and 2, the Near-RT RIC 3 receives a notification indicating a change in the first type of UE identifier from a RAN node that has detected this change. This RAN node may be a target node of a handover of the UE 6. Alternatively, this RAN node may be a RAN node to which the UE 6 has re-established a Radio Resource Control (RRC) connection. For example, the UE 6 re-establishes an RRC connection in response to the detection of a radio link failure (RLF) or in response to a handover failure.

The Near-RT RIC 3 can receive a notification indicating a change in the first type of UE identifier via a RIC INDICATION message on the E2 interface. This RIC INDICATION message may be a RIC INDICATION message based on E2 Service Model (E2SM) RAN Control (RC) REPORT Service Style 4: UE Information. This REPORT service style is initiated by E2SM-RC Event Trigger style 4: UE Information Change. This event trigger style is used to detect changes in UE context information. The UE context information changes supported as event triggers include changes in the UE identifier. The event trigger related to the UE identifier change can be “New UE Connected”, “UE Handed Over”, “UE ID Changed”, or “UE ID Removed”. The New UE Connected event trigger is triggered when a new UE ID is assigned to a newly connected UE. The UE Handed Over event trigger is triggered when a new UE ID is assigned due to a handover from another node. The UE ID Changed event trigger is triggered when the content of the assigned UE ID is changed. The RIC INDICATION message may be triggered by any of these changes in the UE identifier.

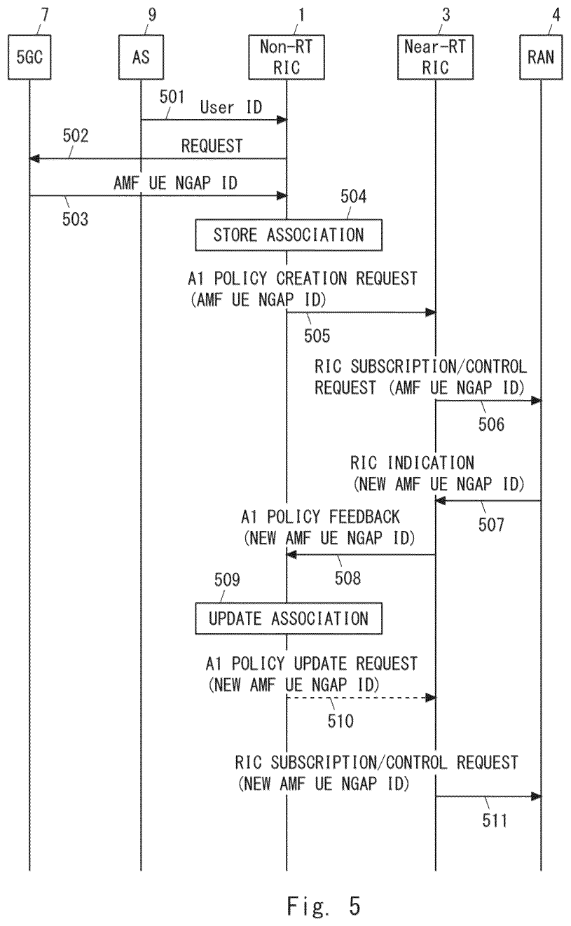

FIG. 5 shows an example of the operation of the Non-RT RIC 1 and the Near-RT RIC 3 in the example configuration of FIG. 1. In step 501, the Non-RT RIC 1 receives the first identifier (e. g., user ID) from the application server (AS) 9. In step 502, the Non-RT RIC 1 queries the 5GC 7 for the first type of UE identifier corresponding to the first identifier. The Non-RT RIC 1 may query the 5GC 7 for the first type of UE identifier using a second identifier associated with the first identifier. As described above, the first type of UE identifier may be an AMF UE NGAP ID. In the following, it is assumed that the first type of UE identifier is an AMF UE NGAP ID. In step 503, the Non-RT RIC 1 receives from the 5GC 7 the first type of UE identifier of the UE 6, i.e., the current value of the first type of UE identifier of the UE 6. In step 504, the Non-RT RIC 1 manages the association between the first identifier (e.g., user ID) and the first type of UE identifier (AMF UE NGAP ID).

In step 505, the Non-RT RIC 1 requests the Near-RT RIC 3 to create or enforce an A1 policy. This policy creation request specifies the first type of UE identifier (AMF UE NGAP ID) to indicate the target UE. Specifically, the first type of UE identifier (AMF UE NGAP ID) may be included in the scope identifier in the policy object included in the policy creation request.

In step 506, the Near-RT RIC 3 initiates control with respect to the UE 6 identified by the AMF UE NGAP ID provided in the A1 policy in order to achieve the goal expressed by one or more policy statements provided in the A1 policy. Specifically, the Near-RT RIC 3 sends one or both of a RIC SUBSCRIPTION REQUEST and a RIC CONTROL REQUEST to a relevant RAN node (e.g., gNB 5) in the RAN 4. The RIC SUBSCRIPTION REQUEST and the RIC CONTROL REQUEST specify the AMF UE NGAP ID. Alternatively, the RIC SUBSCRIPTION REQUEST and the RIC CONTROL REQUEST may specify another UE ID associated with the AMF UE NGAP ID, such as a UE identifier assigned by the RAN node (e.g., gNB-CU UE F1AP ID).

In step 507, the Near-RT RIC 3 receives a RIC INDICATION from the RAN 4 indicating an updated new value of the AMF UE NGAP ID. In step 508, the Near-RT RIC 3 notifies the Non-RT RIC 1 of the new value of the AMF UE NGAP ID. Specifically, the Near-RT RIC 3 may send an extended A1 policy feedback indicating the new value of the AMF UE NGAP ID to the Non-RT RIC 1 over the A1 interface.

In step 509, the Non-RT RIC 1 updates the association between the first identifier (e. g., user ID) and the first type of UE identifier (AMF UE NGAP ID) with the new value of the AMF UE NGAP ID.

In step 510, the Non-RT RIC 1 sends an A1 policy update request to the Near-RT RIC 3, specifying the new value of the AMF UE NGAP ID. The A1 policy update request requests an update of the A1 policy created in step 505. Alternatively, the Non-RT RIC 1 may request the Near-RT RIC 3 to delete the A1 policy created in step 505 and create a new A1 policy for the new value of the AMF UE NGAP ID.

In step 511, the Near-RT RIC 3 performs control related to the UE 6, which is identified by the new value of the AMF UE NGAP ID. In response to the reception of the RIC INDICATION indicating the new value of the AMF UE NGAP ID in step 507, the Near-RT RIC 3 may promptly start the processing in step 511. In other words, the Near-RT RIC 3 may perform step 511 before step 508. Alternatively, the Near-RT RIC 3 may perform step 511 before step 510. In these cases, step 510 may be omitted. The Near-RT RIC 3 may autonomously track or monitor changes in the AMF UE NGAP ID and may request the new RAN node to perform control over the UE 6 in response to the change in the AMF UE NGAP ID. Whether or not the Near-RT RIC 3 should perform this action may be indicated by the A1 policy received in step 505. In other words, the A1 policy in step 505 may explicitly request the Near-RT RIC 3 to continue to perform control over a particular UE while autonomously tracking or monitoring changes in the AMF UE NGAP ID.

The operations described with reference to FIG. 5 allow the Non-RT RIC 1 and the Near-RT RIC 3 to identify a target UE based on user identification information (first identifier) specified by an external server or entity such as the application server 9, and to perform continuous control over the target UE.

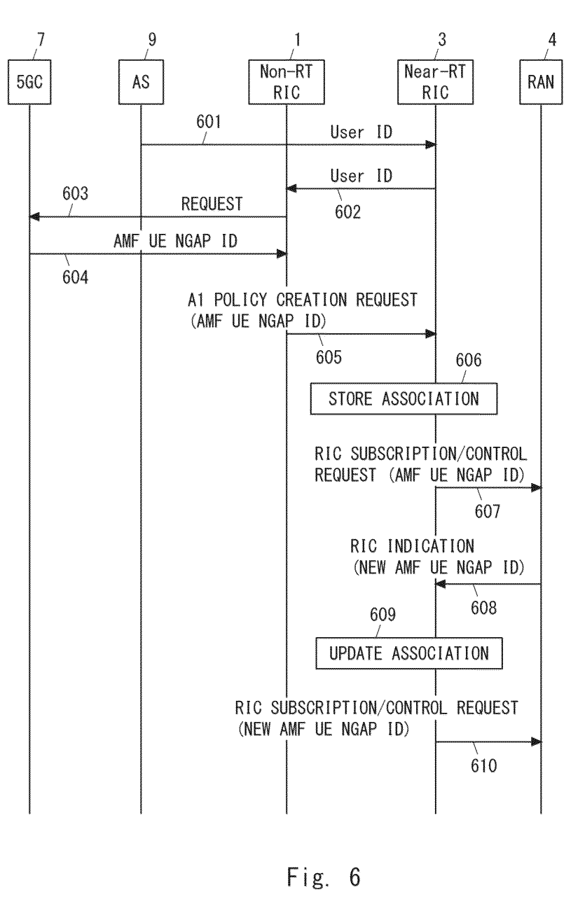

FIG. 6 shows an example of the operation of the Non-RT RIC 1 and the Near-RT RIC 3 in the example configuration of FIG. 2. In step 601, the Near-RT RIC 3 receives the first identifier (e. g., user ID) from the application server 9. In step 602, the Near-RT RIC 3 sends the first identifier (e. g., user ID) to the Non-RT RIC 1. The Near-RT RIC 3 may send the first identifier (e.g., user ID) to the Non-RT RIC 1 over the A1 interface. Steps 603 and 604 are the same as steps 502 and 503 in FIG. 5. As described above, the first type of UE identifier can be an AMF UE NGAP ID. In the following, it is assumed that the first type of UE identifier is an AMF UE NGAP ID.

In step 605, the Non-RT RIC 1 sends the first type of UE identifier (AMF UE NGAP ID) to the Near-RT RIC 3. In one example, the Non-RT RIC 1 requests the Near-RT RIC 3 to create or enforce an A1 policy. This policy creation request specifies the first type of UE identifier (AMF UE NGAP ID) to indicate the target UE. Specifically, the first type of UE identifier (AMF UE NGAP ID) may be included in the scope identifier in the policy object included in the policy creation request. The A1 policy may further specify the first identifier (e. g., user ID). The A1 policy may explicitly require the Near-RT RIC 3 to autonomously track or monitor changes in the AMF UE NGAP ID and to continue to perform control over the particular UE.

In step 606, the Near-RT RIC 3 manages the association between the first identifier (e. g., user ID) and the first type of UE identifier (AMF UE NGAP ID).

Steps 607 and 608 are the same as steps 506 and 507 in FIG. 5. In step 609, the Near-RT RIC 3 updates the association between the first identifier (e.g., user ID) and the first type of UE identifier (AMF UE NGAP ID) with the new value of the AMF UE NGAP ID. In step 610, the Near-RT RIC 3 performs control with respect to the UE 6, which is identified by the new value of the AMF UE NGAP ID. In other words, the Near-RT RIC 3 autonomously tracks or monitors changes in the AMF UE NGAP ID and promptly requests the new RAN node to perform control over the UE 6 in response to a change in the AMF UE NGAP ID.

The operations described with reference to FIG. 6 allow the Non-RT RIC 1 and the Near-RT RIC 3 to identify a target UE based on user identification information (first identifier) specified by an external server or entity such as the application server 9, and to perform continuous control over the target UE.

### Second Example Embodiment

An example configuration of a radio communication system according to this example embodiment may be the same as the example shown in FIG. 1 or FIG. 2. This example embodiment provides examples of operations performed by the Non-RT RIC 1, the Near-RT RIC 3, or a combination of the two.

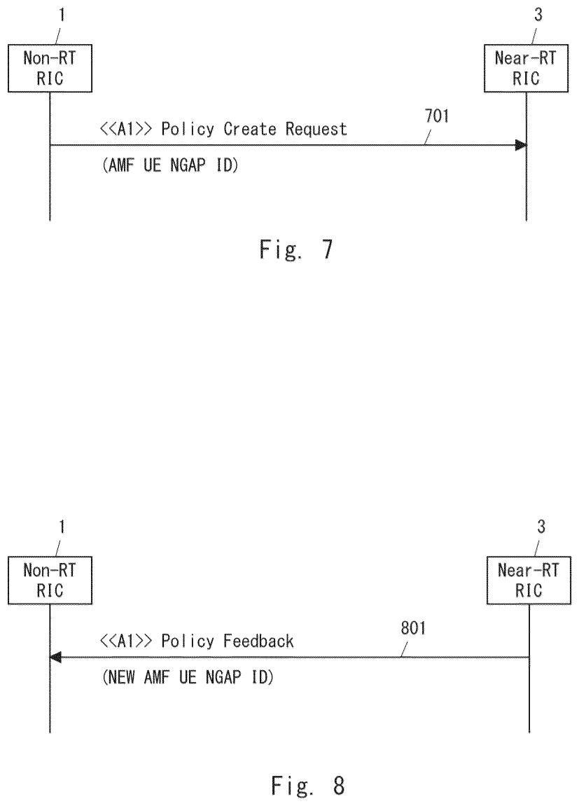

FIG. 7 shows an example of the operation of the Non-RT RIC 1 and the Near-RT RIC 3. In step 701, the Non-RT RIC 1 sends or provides a first type of UE identifier of the UE 6, which is assigned by the core network (e. g., 5GC 7), to the Near-RT RIC 3. The Non-RT RIC 1 may send the first type of UE identifier over the A1 interface.

The first type of UE identifier may be assigned by the core network on a control interface (e.g., N2 or NG-C interface) between the core network (e. g., 5GC 7 or EPC) and the RAN 4. In other words, the first type of UE identifier may be assigned by the core network to identify the UE 6 on the control interface between the core network and the RAN 4. The first type of UE identifier may be assigned by a control node (e.g., AMF or MME) located within the core network (e.g., 5GC 7 or EPC) and providing mobility management for the UE 6. If the first type of UE identifier is obtained from the 5GC 7, the first type of UE identifier may include an AMF UE NGAP ID, or it may be a combination of an AMF UE NGAP ID and an AMF identifier. The AMF identifier may be all or part of a GUAMI. If the first type of UE identifier is obtained from the EPC, the first type of UE identifier may include an MME UE S1AP ID, or it may be a combination of an MME UE S1AP ID and an MME identifier. The MME identifier may be all or part of a GUMMEI.

As shown in FIG. 7, the Non-RT RIC 1 may request the Near-RT RIC 3 based on the AMF UE NGAP to create or enforce an A1 policy with respect to the UE 6. In other words, the Non-RT RIC 1 may request the Near-RT RIC 3 to create or enforce an A1 policy with respect to the UE 6 identified by the AMF UE NGAP. The policy creation request causes the Near-RT RIC 3 to request one or more RAN nodes to perform control with respect to the UE 6 using the first type of UE identifier or a second type of UE identifier associated with the first type of UE identifier. In this case, the UE identifier contained in the scope identifier in the A1 policy may be extended to specify the first type of UE identifier (e. g., AMF UE NGAP ID and AMF identifier). The A1 policy consists of the scope identifier and the one or more policy statements. The scope identifier indicates the target to which the policy statement(s) are to be applied (e.g., UEs, QoS flows, or cells). The policy statement(s) represent the goals to the Near-RT RIC 3 and cover policy objectives and policy resources.

The operation described with reference to FIG. 7 allows the Non-RT RIC 1 to indicate to the Near-RT RIC 3 a UE identifier (e.g., AMF UE NGAP ID) assigned by the core network (e.g., 5GC 7) rather than by the RAN 4.

### Third Example Embodiment

An example configuration of a radio communication system according to this example embodiment may be the same as the example shown in FIG. 1 or FIG. 2. This example embodiment provides examples of operations performed by the Non-RT RIC 1, the Near-RT RIC 3, or a combination of the two.

FIG. 8 shows an example of the operation of the Non-RT RIC 1 and the Near-RT RIC 3. In step 801, the Near-RT RIC 3 sends a notification to the Non-RT RIC 1 indicating a change in the value of a first type of UE identifier (e.g., AMF UE NGAP ID) of the UE 6, which has been assigned by the core network (e. g., 5GC 7). The Near-RT RIC 3 may send the notification over the A1 interface. The notification may specify the changed value of the first type of UE identifier. The notification may specify the old value before the change and the new value after the change of the first type of UE identifier.

The first type of UE identifier may be assigned by the core network on a control interface (e.g., N2 or NG-C interface) between the core network (e. g., 5GC 7 or EPC) and the RAN 4. In other words, the first type of UE identifier may be assigned by the core network to identify the UE 6 on the control interface between the core network and the RAN 4. The first type of UE identifier may be assigned by a control node (e.g., AMF or MME) located within the core network (e. g., 5GC 7 or EPC) and providing mobility management for the UE 6. If the first type of UE identifier is obtained from the 5GC 7, the first type of UE identifier may include an AMF UE NGAP ID, or it may be a combination of an AMF UE NGAP ID and an AMF identifier. The AMF identifier may be all or part of a GUAMI. If the first type of UE identifier is obtained from the EPC, the first type of UE identifier may include an MME UE S1AP ID, or it may be a combination of an MME UE S1AP ID and an MME identifier. The MME identifier may be all or part of a GUMMEI.

As shown in FIG. 8, the Near-RT RIC 3 may send a notification to the Non-RT RIC 1 indicating a change in the value of the first type of UE identifier (e.g., AMF UE NGAP ID) via A1 policy feedback. The A1 policy feedback may be enhanced or extended to indicate the changed value of the first type of identifier. Alternatively, the A1 policy feedback may be enhanced or extended to indicate the old value before the change and the new value after the change of the first type of UE identifier.

In another example, the Near-RT RIC 3 may send a notification to the Non-RT RIC 1 indicating a change in the value of the first type of UE identifier in one or more new A1 policy procedures different from the feedback policy procedure. The newly defined procedure(s) may include a push-type procedure similar to the feedback policy procedure. Alternatively, the newly defined procedure(s) may include a pull-type procedure involving a query from the Non-RT RIC 1 and a response from the Near-RT RIC 3.

In response to receiving a notification of a change in the first type of UE identifier via a policy feedback or other procedure, the Non-RT RIC 1 may, if necessary, send a request to the Near-RT RIC 3 to update an A1 policy. The updated A1 policy may specify the changed value of the first type of UE identifier and may also specify one or more policy statements with respect to the UE 6 identified by the changed value. The updated A1 policy may cause the Near-RT RIC 3 to request the RAN 4 to perform control with respect to the UE 6 identified by the changed value.

Based on notifications of a change in the value of the first type of UE identifier via policy feedback or other procedures, the Non-RT RIC 1 may track or monitor the change in the value of the first type of UE identifier. In some implementations, based on such notifications, the Non-RT RIC 1 may maintain an association between the first type of UE identifier and user identification information (first identifier) specified by an external server or entity, such as the application server 9. Examples of the first identifier may be similar to those described in the first example embodiment.

The operation shown in FIG. 8 can be used in combination with the operation shown in FIG. 7, which is explained in the second example embodiment. Specifically, as explained with reference to FIG. 7, the Non-RT RIC 1 may provide the first type of UE identifier to the Near-RT RIC 3 by requesting the Near-RT RIC 3 to create or enforce an A1 policy defined using the first type of UE identifier (e.g., AMF UE NGAP ID). The Near-RT RIC 3 may then send a notification to the Near-RT RIC 3 indicating a change in the value of the first type of UE identifier via policy feedback for the A1 policy.

According to the behavior described with reference to FIG. 8, the Near-RT RIC 3 can notify the Non-RT RIC 1 of a change in the value of a UE identifier assigned by the core network (e.g., 5GC 7) rather than by the RAN 4. In particular, this notification may be sent via the A1 interface. In general, information collection over the A1 interface is performed in less time than information collection over the O1 interface. Accordingly, the Non-RT RIC 1 may learn of changes in the value of the first type of UE identifier more quickly than when using the O1 interface.

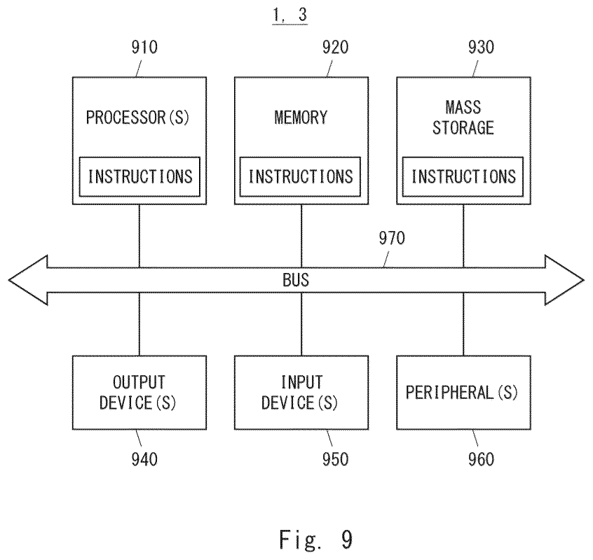

Examples of configurations of the Non-RT RIC 1 and the Near-RT RIC 3 according to the example embodiments described above are provided below. FIG. 9 is a block diagram showing an example configuration of the Non-RT RIC 1. The Near-RT RIC 3 may also have a configuration similar to that shown in FIG. 9.

In the example in FIG. 9, the Non-RT RIC 1 is implemented as a computer system. The computer system includes one or more processors 910, a memory 920, and a mass storage 930, which communicate with one another via a bus 970. The one or more processors 910 may include, for example, one or both of a Central Processing Unit (CPU) and a Graphics Processing Unit (GPU). The computer system may include other devices, such as one or more output devices 940, one or more input devices 950, and one or more peripherals 960. The one or more peripheral devices 960 may include a modem, or network adapter, or any combination thereof.

One or both of the memory 920 and the mass storage 930 include a computer-readable medium storing one or more sets of instructions. Some or all of these instructions may be stored in a memory in the one or more processors 910. These instructions, when executed in the one or more processors 910, cause the one or more processors 910 to provide the functions of the Non-RT RIC 1 described in the above example embodiments.

As explained using FIG. 9, each of the processors of the Non-RT RIC 1 and the Near-RT RIC 3 according to the above example embodiments is capable of executing one or more programs containing a set of instructions for causing a computer to perform the algorithm described with reference to the drawings. The program(s) contains a set of instructions (or software codes) that, when loaded into a computer, causes the computer to perform one or more of the functions described in the example embodiments. The program(s) may be stored in a non-transitory computer readable medium or a tangible storage medium. By way of example, and not limitation, non-transitory computer readable media or tangible storage media can include a random-access memory (RAM), a read-only memory (ROM), a flash memory, a solid-state drive (SSD) or other memory technologies, CD-ROM, digital versatile disk (DVD), Blu-ray (registered mark) disc or other optical disk storage, magnetic cassettes, magnetic tape, magnetic disk storage or other magnetic storage devices. The program(s) may be transmitted on a transitory computer readable medium or a communication medium. By way of example, and not limitation, transitory computer readable media or communication media can include electrical, optical, acoustical, or other form of propagated signals.

The above-described example embodiments are merely examples of the application of the technical ideas obtained by the inventors. These technical ideas are not limited to the above-described example embodiments and various modifications can be made thereto.

For example, the whole or part of the example embodiments disclosed above can be described as, but not limited to, the following supplementary notes.

### Supplementary Note 1

A Radio Access Network (RAN) Intelligent Controller (RIC) comprising:
at least one memory; and
at least one processor coupled to the at least one memory and configured to:
   obtain a first identifier associated with a User Equipment (UE);
   obtain a first type of UE identifier corresponding to the first identifier from a core network; and
   use the first type of UE identifier or a second type of UE identifier associated with the first type of UE identifier to cause one or more radio access network (RAN) nodes in a RAN to perform control with respect to the UE.

### Supplementary Note 2

The RIC according to Supplementary Note 1, wherein the at least one processor is configured to track or monitor changes in a value of the first type of UE identifier based on a notification from the RAN.

### Supplementary Note 3

The RIC according to Supplementary Note 1, wherein the at least one processor is configured to receive a notification from the RAN indicating a change in a value of the first type of UE identifier and to update an association between the first identifier and the first type of UE identifier.

### Supplementary Note 4

The RIC according to Supplementary Note 2 or 3, wherein
the RIC comprises an Open Radio Access Network (O-RAN) Non-Real-Time (Non-RT) RIC, and
the at least one processor is configured to receive, via an A1 interface, the notification indicating a change in the value of the first type of UE identifier from an O-RAN Near-Real-Time (Near-RT) RIC.

### Supplementary Note 5

The RIC according to Supplementary Note 4, wherein the at least one processor is configured to request the Near-RT RIC, based on the first type of UE identifier, to enforce a policy with respect to the UE.

### Supplementary Note 6

The RIC according to Supplementary Note 4, wherein the at least one processor is configured to:
provide the first type of UE identifier to the Near-RT RIC by requesting the Near-RT RIC to create or enforce an A1 policy defined using the first type of UE identifier; and
receive from the Near-RT RIC the notification indicating a change in the value of the first type of UE identifier via feedback regarding the A1 policy.

### Supplementary Note 7

The RIC according to any one of Supplementary Notes 4 to 6, wherein the at least one processor is configured to obtain the first identifier from an application server located external to the Non-RT RIC and the Near-RT RIC, via an external interface provided by the Non-RT RIC or by a Service Management and Orchestration (SMO) framework in which the Non-RT RIC is deployed.

### Supplementary Note 8

The RIC according to any one of Supplementary Notes 4 to 7, wherein the at least one processor is configured to:
request the core network to provide the first type of UE identifier using the first identifier or a second identifier associated with the first identifier; and
receive the first type of UE identifier from the core network.

### Supplementary Note 9

The RIC according to Supplementary Note 8, wherein the second identifier comprises a Subscription Permanent Identifier (SUPI), an International Mobile Subscriber Identity (IMSI), or a Generic Public Subscription Identifier (GPSI).

### Supplementary Note 10

The RIC according to Supplementary Note 2 or 3, wherein
the RIC comprises an Open Radio Access Network (O-RAN) Near-Real-Time (Near-RT) RIC, and
the at least one processor is configured to receive from an O-RAN Non-Real-Time (Non-RT) RIC the first type of UE identifier obtained by the Non-RT RIC from the core network.

### Supplementary Note 11

The RIC according to Supplementary Note 10, wherein the at to:
obtain the first identifier from an application server located external to the Non-RT RIC and the Near-RT RIC; and
request the Non-RT RIC to provide the first type of UE identifier corresponding to the first identifier.

### Supplementary Note 12

The RIC according to Supplementary Note 11, wherein the at least one processor is configured to:
send the first identifier to the Non-RT RIC via a request to create or enforce an A1 enrichment information job indicating the first identifier; and
receive the first type of UE identifier from the Non-RT RIC using a delivery procedure to provide a result of the A1 enrichment information job.

### Supplementary Note 13

The RIC according to any one of Supplementary Notes 1 to 12, wherein the first type of UE identifier is assigned by the core network.

### Supplementary Note 14

The RIC according to any one of Supplementary Notes 1 to 13, wherein the first type of UE identifier is assigned by the core network on a control interface between the core network and the RAN.

### Supplementary Note 15

The RIC according to any one of Supplementary Notes 1 to 14, wherein the first type of UE identifier is assigned by a control node located in the core network and providing mobility management for the UE.

### Supplementary Note 16

The RIC according to Supplementary Note 15, wherein the control node is an Access and Mobility Management Function (AMF) or a Mobility Management Entity (MME).

### Supplementary Note 17

The RIC according to any one of Supplementary Notes 1 to 16, wherein the first type of UE identifier comprises an Access and Mobility Management Function (AMF) UE NG Application Protocol (NGAP) ID or a Mobility Management Entity (MME) UE S1 Application Protocol (S1AP) ID.

### Supplementary Note 18

The RIC according to any one of Supplementary Notes 1 to 17, wherein the second type of UE identifier is a UE identifier used in a case where Central Unit (CU)-Distributed Unit (DU) separation of a RAN node is applied, a UE identifier used in a case where Control Plane (CP)-User Plane (UP) separation of a RAN node is applied, or a UE identifier used in a case where Dual Connectivity is set up.

### Supplementary Note 19

The RIC according to any one of Supplementary Notes 1 to 18,wherein the first identifier comprises an identifier for identifying a machine, vehicle, or device that uses the UE or in which the UE is implemented.

### Supplementary Note 20

The RIC according to any one of Supplementary Notes 1 to 18, wherein the first identifier comprises an identifier for identifying a user or application using the UE.

### Supplementary Note 21

The RIC according to any one of Supplementary Notes 1 to 18, wherein the first identifier comprises an Internet Protocol (IP) address for identifying a packet transfer service, Protocol Data Unit (PDU) Session, or Packet Data Network (PDN) Connection used by the UE.

### Supplementary Note 22

A method performed by a Radio Access Network (RAN) Intelligent Controller (RIC), the method comprising:
obtaining a first identifier associated with a User Equipment (UE);
obtaining a first type of UE identifier corresponding to the first identifier from a core network; and
using the first type of UE identifier or a second type of UE identifier associated with the first type of UE identifier to cause one or more radio access network (RAN) nodes in a RAN to perform control with respect to the UE.

### Supplementary Note 23

A program for causing a computer to perform a method for a Radio Access Network (RAN) Intelligent Controller (RIC), the method comprising:
obtaining a first identifier associated with a User Equipment (UE);
obtaining a first type of UE identifier corresponding to the first identifier from a core network; and
using the first type of UE identifier or a second type of UE identifier associated with the first type of UE identifier to cause one or more radio access network (RAN) nodes in a RAN to perform control with respect to the UE.

### Supplementary Note 24

A first Radio Access Network (RAN) Intelligent Controller (RIC) comprising:
at least one memory; and
at least one processor coupled to the at least one memory and configured to:
   send a first type of UE identifier of a User Equipment (UE) assigned by a core network to a second RIC located between the first RIC and a radio access network (RAN).

### Supplementary Note 25

The first RIC according to Supplementary Note 24, wherein the at least one processor is configured to send the first type of UE identifier to the second RIC on an A1 interface.

### Supplementary Note 26

The first RIC according to Supplementary Note 24 or 25, wherein the first type of UE identifier is assigned by the core network on a control interface between the core network and the RAN.

### Supplementary Note 27

The first RIC according to any one of Supplementary Notes 24 to 26, wherein the first type of UE identifier is assigned by a control node located in the core network and providing mobility management for the UE.

### Supplementary Note 28

The first RIC according to Supplementary Note 27, wherein the control node is an Access and Mobility Management Function (AMF) or a Mobility Management Entity (MME).

### Supplementary Note 29

The first RIC according to any one of Supplementary Notes 24 to 28, wherein the first type of UE identifier comprises an Access and Mobility Management Function (AMF) UE NG Application Protocol (NGAP) ID or a Mobility Management Entity (MME) UE S1 Application Protocol (S1AP) ID.

### Supplementary Note 30

The first RIC according to any one of Supplementary Notes 24 to 29, wherein the at least one processor is configured to receive a notification from the second RIC indicating a change in a value of the first type of UE identifier.

### Supplementary Note 31

The first RIC according to Supplementary Note 30, wherein the at least one processor is configured to track or monitor changes in the value of the first type of UE identifier based on the notification.

### Supplementary Note 32

The first RIC according to Supplementary Note 30 or 31, wherein the at least one processor is configured to update an association between the first type of UE identifier and a first identifier associated with the UE.

### Supplementary Note 33

The first RIC according to any one of Supplementary Notes 30 to 32, wherein the notification indicates a changed new value of the first type of UE identifier.

### Supplementary Note 34

The first RIC according to any one of Supplementary Notes 30 to 32, wherein the notification indicates an old value before change and a new value after change of the first type of UE identifier.

### Supplementary Note 35

The first RIC according to any one of Supplementary Notes 24 to 34, wherein the at least one processor is configured to request the second RIC, based on the first type of UE identifier, to enforce a policy with respect to the UE.

### Supplementary Note 36

The first RIC according to Supplementary Note 35, wherein the request causes the second RIC to request one or more RAN nodes using the first type of UE identifier or a second type of UE identifier associated with the first type of UE identifier to perform control with respect to the UE.

### Supplementary Note 37

The first RIC according to any one of Supplementary Notes 30 to 34, wherein the at least one processor is configured to:
provide the first type of UE identifier to the second RIC by requesting the second RIC to create or enforce an A1 policy defined using the first type of UE identifier; and
receive from the second RIC the notification indicating a change in the value of the first type of UE identifier via feedback regarding the A1 policy.

### Supplementary Note 38

The first RIC according to Supplementary Note 37, wherein the at least one processor is configured to request the second RIC to update the A1 policy based on the feedback.

### Supplementary Note 39

The first RIC according to any one of Supplementary Notes 24 to 38, wherein
the first RIC is an Open Radio Access Network (O-RAN) Non-Real-Time (Non-RT) RIC, and
the second RIC is an O-RAN Near-Real-Time (Near-RT) RIC.

### Supplementary Note 40

A method performed by a first Radio Access Network (RAN) Intelligent Controller (RIC), the method comprising:
sending a first type of UE identifier of a User Equipment (UE) assigned by a core network to a second RIC located between the first RIC and a radio access network (RAN).

### Supplementary Note 41

A program for causing a computer to perform a method for a first Radio Access Network (RAN) Intelligent Controller (RIC), the method comprising:
sending a first type of UE identifier of a User Equipment (UE) assigned by a core network to a second RIC located between the first RIC and a radio access network (RAN).

### Supplementary Note 42

A second Radio Access Network (RAN) Intelligent Controller (RIC) to be deployed between a first RIC and a radio access network (RAN), the second RIC comprising:
at least one memory; and
at least one processor coupled to the at least one memory and configured to:
   receive from the first RIC a first type of UE identifier of a User Equipment (UE) assigned by a core network.

### Supplementary Note 43

The second RIC according to Supplementary Note 42, wherein the at least one processor is configured to receive the first type of UE identifier from the first RIC on an A1 interface.

### Supplementary Note 44

The second RIC according to Supplementary Note 42 or 43, wherein the first type of UE identifier is assigned by the core network on a control interface between the core network and the RAN.

### Supplementary Note 45

The second RIC according to any one of Supplementary Notes 42 to 44, wherein the first type of UE identifier is assigned by a control node located in the core network and providing mobility management for the UE.

### Supplementary Note 46

The second RIC according to Supplementary Note 45, wherein the control node is an Access and Mobility Management Function (AMF) or a Mobility Management Entity (MME).

### Supplementary Note 47

The second RIC according to any one of Supplementary Notes 42 to 46, wherein the first type of UE identifier comprises an Access and Mobility Management Function (AMF) UE NG Application Protocol (NGAP) ID or a Mobility Management Entity (MME) UE S1 Application Protocol (S1AP) ID.

### Supplementary Note 48

The second RIC according to any one of Supplementary Notes 42 to 47, wherein the at least one processor is configured to send a notification to the first RIC indicating a change in a value of the first type of UE identifier.

### Supplementary Note 49

The second RIC according to Supplementary Note 48, wherein the notification allows the first RIC to track or monitor changes in the value of the first type of UE identifier.

### Supplementary Note 50

The second RIC according to Supplementary Note 48 or 49, wherein the notification allows the first RIC to update an association between the first type of UE identifier and a first identifier associated with the UE.

### Supplementary Note 51

The second RIC according to any one of Supplementary Notes 48 to 50, wherein the notification indicates a changed new value of the first type of UE identifier.

### Supplementary Note 52

The second RIC according to any one of Supplementary Notes 48 to 50, wherein the notification indicates an old value before change and a new value after change of the first type of UE identifier.

### Supplementary Note 53

The second RIC according to any one of Supplementary Notes 48 to 52, wherein the at least one processor is configured to:
receive the first type of UE identifier from the first RIC via a request to create or enforce an A1 policy defined using the first type of UE identifier; and
send to the first RIC the notification indicating a change in the value of the first type of UE identifier via feedback regarding the A1 policy.

### Supplementary Note 54

The second RIC according to Supplementary Note 53, wherein the at least one processor is configured to receive a request from the first RIC to update the A1 policy based on the feedback.

### Supplementary Note 55

A method performed by a second Radio Access Network (RAN) Intelligent Controller (RIC) to be deployed between a first RIC and a radio access network (RAN), the method comprising:
receiving from the first RIC a first type of UE identifier of a User Equipment (UE) assigned by a core network.

### Supplementary Note 56

A program for causing a computer to perform a method for a second Radio Access Network (RAN) Intelligent Controller (RIC) that is to be deployed between a first RIC and a radio access network (RAN), the method comprising:
receiving from the first RIC a first type of UE identifier of a User Equipment (UE) assigned by a core network.

### Supplementary Note 57

A first Radio Access Network (RAN) Intelligent Controller (RIC) comprising:
at least one memory; and
at least one processor coupled to the at least one memory and configured to:
   receive, from a second RIC located between the first RIC and a radio access network (RAN), a notification indicating a change in a value of a first type of UE identifier of a User Equipment (UE) assigned by a core network.

### Supplementary Note 58

The first RIC according to Supplementary Note 57, wherein the at least one processor is configured to receive the notification from the second RIC on an A1 interface.

### Supplementary Note 59

The first RIC according to Supplementary Note 57 or 58, wherein the notification indicates a changed value of the first type of UE identifier,

### Supplementary Note 60

The first RIC according to Supplementary Note 57 or 58, wherein the notification indicates an old value before change and a new value after change of the first type of UE identifier.

### Supplementary Note 61

The first RIC according to any one of Supplementary Notes 57 to 60, wherein the first type of UE identifier is assigned by the core network on a control interface between the core network and the RAN.

### Supplementary Note 62

The first RIC according to any one of Supplementary Notes 57 to 61, wherein the first type of UE identifier is assigned by a control node located in the core network and providing mobility management for the UE.

### Supplementary Note 63

The first RIC according to Supplementary Note 62, wherein the control node is an Access and Mobility Management Function (AMF) or a Mobility Management Entity (MME).

### Supplementary Note 64

The first RIC according to any one of Supplementary Notes 57 to 63, wherein the first type of UE identifier comprises an Access and Mobility Management Function (AMF) UE NG Application Protocol (NGAP) ID or a Mobility Management Entity (MME) UE S1 Application Protocol (S1AP) ID.

### Supplementary Note 65

The first RIC according to any one of Supplementary Notes 57 to 64, wherein the at least one processor is configured to:
provide the first type of UE identifier to the second RIC by requesting the second RIC to create or enforce an A1 policy defined using the first type of UE identifier; and
receive from the second RIC the notification indicating a change in the value of the first type of UE identifier via feedback regarding the A1 policy.

### Supplementary Note 66

The first RIC according to any one of Supplementary Notes 57 to 65, wherein the at least one processor is configured to track or monitor changes in the value of the first type of UE identifier based on the notification.

### Supplementary Note 67

The first RIC according to any one of Supplementary Notes 57 to 66, wherein the at least one processor is configured to update an association between the first type of UE identifier and a first identifier associated with the UE.

### Supplementary Note 68

The first RIC according to Supplementary Note 67, wherein the first identifier comprises an identifier for identifying a machine, vehicle, or device that uses the UE or in which the UE is implemented.

### Supplementary Note 69

The first according to Supplementary Note 67, wherein the first identifier comprises an identifier for identifying a user or application using the UE.

### Supplementary Note 70

The first RIC according to Supplementary Note 67, wherein the first identifier comprises an Internet Protocol (IP) address for identifying a packet transfer service, Protocol Data Unit (PDU) Session, or Packet Data Network (PDN) Connection used by the UE.

### Supplementary Note 71

A method performed by a first Radio Access Network (RAN) Intelligent Controller (RIC), the method comprising:
receiving, from a second RIC located between the first RIC and a radio access network (RAN), a notification indicating a change in a value of a first type of UE identifier of a User Equipment (UE) assigned by a core network.

### Supplementary Note 72

A program for causing a computer to perform a method for a first Radio Access Network (RAN) Intelligent Controller (RIC), the method comprising:
receiving, from a second RIC located between the first RIC and a radio access network (RAN), a notification indicating a change in a value of a first type of UE identifier of a User Equipment (UE) assigned by a core network.

### Supplementary Note 73

A second Radio Access Network (RAN) Intelligent Controller (RIC) to be deployed between a first RIC and a radio access network (RAN), the second RIC comprising:
at least one memory; and
at least one processor coupled to the at least one memory and configured to:
   send to the first RIC a notification indicating a change in a value of a first type of UE identifier of a User Equipment (UE) assigned by a core network.

### Supplementary Note 74

The second RIC according to Supplementary Note 73, wherein the at least one processor is configured to send the notification to the first RIC on an A1 interface.

### Supplementary Note 75

The second RIC according to Supplementary Note 73 or 74, wherein the notification indicates a changed value of the first type of UE identifier,

### Supplementary Note 76

The second RIC according to Supplementary Note 73 or 74, wherein the notification indicates an old value before change and a new value after change of the first type of UE identifier.

### Supplementary Note 77

The second RIC according to any one of Supplementary Notes 73 to 76, wherein the first type of UE identifier is assigned by the core network on a control interface between the core network and the RAN.

### Supplementary Note 78

The second RIC according to any one of Supplementary Notes 73 to 76, wherein the first type of UE identifier is assigned by a control node located in the core network and providing mobility management for the UE.

### Supplementary Note 79

The second RIC according to Supplementary Note 78, wherein the control node is an Access and Mobility Management Function (AMF) or a Mobility Management Entity (MME).

### Supplementary Note 80

The second RIC according to any one of Supplementary Notes 73 to 79, wherein the first type of UE identifier comprises an Access and Mobility Management Function (AMF) UE NG Application Protocol (NGAP) ID or a Mobility Management Entity (MME) UE S1 Application Protocol (S1AP) ID.

### Supplementary Note 81

The second RIC according to any one of Supplementary Notes 73 to 80, wherein the at least one processor is configured to:
receive the first type of UE identifier from the first RIC via a request to create or enforce an A1 policy defined using the first type of UE identifier; and
send to the first RIC the notification indicating a change in the value of the first type of UE identifier via feedback regarding the A1 policy.

### Supplementary Note 82

A method performed by a second Radio Access Network (RAN) Intelligent Controller (RIC) to be deployed between a first RIC and a radio access network (RAN), the method comprising:
sending to the first RIC a notification indicating a change in a value of a first type of UE identifier of a User Equipment (UE) assigned by a core network.

### Supplementary Note 83

A program for causing a computer to perform a method for a second Radio Access Network (RAN) Intelligent Controller (RIC) that is to be deployed between a first RIC and a radio access network (RAN), the method comprising:
sending to the first RIC a notification indicating a change in a value of a first type of UE identifier of a User Equipment (UE) assigned by a core network.

This application is based upon and claims the benefit of priority from Japanese Patent Application No. 2022-128679, filed on Aug. 12, 2022, the disclosure of which is incorporated herein in its entirety by reference.

### REFERENCE SIGNS LIST

1 Non-RT RIC
2 SMO framework
3 Near-RT RIC
4 RAN
5 gNB
6 UE
7 5GC
9 Application server
910 Processor
920 Memory
930 Mass storage

What is claimed is:

1-21. (canceled)

22. A method performed by a Radio Access Network (RAN) Intelligent Controller (RIC), the method comprising:
obtaining a first identifier associated with a User Equipment (UE);
obtaining a first type of UE identifier corresponding to the first identifier from a core network; and
using the first type of UE identifier or a second type of UE identifier associated with the first type of UE identifier to cause one or more radio access network (RAN) nodes in a RAN to perform control with respect to the UE.

23-39. (canceled)

40. A method performed by a first Radio Access Network (RAN) Intelligent Controller (RIC), the method comprising:
sending a first type of UE identifier of a User Equipment (UE) assigned by a core network to a second RIC located between the first RIC and a radio access network (RAN).

41-54. (canceled)

55. A method performed by a second Radio Access Network (RAN) Intelligent Controller (RIC) to be deployed between a first RIC and a radio access network (RAN), the method comprising:
receiving from the first RIC a first type of UE identifier of a User Equipment (UE) assigned by a core network.

56-83. (canceled)

84. The method according to claim 22, further comprising tracking or monitoring changes in a value of the first type of UE identifier based on a notification from the RAN.

85. The method according to claim 22, further comprising:
receiving a notification from the RAN indicating a change in a value of the first type of UE identifier; and
updating an association between the first identifier and the first type of UE identifier.

86. The method according to claim 84, wherein
the RIC comprises an Open Radio Access Network (O-RAN) Non-Real-Time (Non-RT) RIC, and
the receiving the notification comprises receiving, via an A1 interface, the notification indicating a change in the value of the first type of UE identifier from an O-RAN Near-Real-Time (Near-RT) RIC.

87. The method according to claim 86, further comprising requesting the Near-RT RIC, based on the first type of UE identifier, to enforce a policy with respect to the UE.

88. The method according to claim 86, further comprising providing the first type of UE identifier to the Near-RT RIC by requesting the Near-RT RIC to create or enforce an A1 policy defined using the first type of UE identifier,
wherein the receiving the notification comprises receiving from the Near-RT RIC the notification indicating a change in the value of the first type of UE identifier via feedback regarding the A1 policy.

89. The method according to claim 86, wherein the obtaining the first identifier comprises obtaining the first identifier from an application server located external to the Non-RT RIC and the Near-RT RIC, via an external interface provided by the Non-RT RIC or by a Service Management and Orchestration (SMO) framework in which the Non-RT RIC is deployed.

90. The method according to claim 86, further comprising requesting the core network to provide the first type of UE identifier using the first identifier or a second identifier associated with the first identifier.

91. The method according to claim 84, wherein
the RIC comprises an Open Radio Access Network (O-RAN) Near-Real-Time (Near-RT) RIC, and
the obtaining the first type of UE identifier comprises receiving from an O-RAN Non-Real-Time (Non-RT) RIC the first type of UE identifier obtained by the Non-RT RIC from the core network.

92. The method according to claim 91, wherein
the obtaining the first identifier comprises obtaining the first identifier from an application server located external to the Non-RT RIC and the Near-RT RIC, and
the obtaining the first type of UE identifier comprises requesting the Non-RT RIC to provide the first type of UE identifier corresponding to the first identifier.

93. The method according to claim 92, wherein the obtaining the first type of UE identifier comprises:
sending the first identifier to the Non-RT RIC via a request to create or enforce an A1 enrichment information job indicating the first identifier; and
receiving the first type of UE identifier from the Non-RT RIC using a delivery procedure to provide a result of the A1 enrichment information job.

94. The method according to claim 22, wherein the second type of UE identifier is a UE identifier used in a case where Central Unit (CU)-Distributed Unit (DU) separation of a RAN node is applied, a UE identifier used in a case where Control Plane (CP)-User Plane (UP) separation of a RAN node is applied, or a UE identifier used in a case where Dual Connectivity is set up.

95. The method according to claim 40, wherein
the sending comprises providing the first type of UE identifier to the second RIC by requesting the second RIC to create or enforce an A1 policy defined using the first type of UE identifier, and
the method further comprises receiving a notification from the second RIC indicating a change in a value of the first type of UE identifier via feedback regarding the A1 policy.

96. The method according to claim 95, further comprising requesting the second RIC to update the A1 policy based on the feedback.

97. The method according to claim 55, wherein the receiving comprises receiving the first type of UE identifier from the first RIC on an A1 interface.

98. The method according to claim 55, further comprising sending a notification to the first RIC indicating a change in a value of the first type of UE identifier.

99. The method according to claim 98, wherein
the receiving comprises receiving the first type of UE identifier from the first RIC via a request to create or enforce an A1 policy defined using the first type of UE identifier, and
the sending comprises sending to the first RIC the notification indicating a change in the value of the first type of UE identifier via feedback regarding the A1 policy.

100. The method according to claim 99, further comprising receiving a request from the first RIC to update the A1 policy based on the feedback.
